(19) United States
(12) Patent Application Publication
(10) Pub. No.: US 2026/0339256 A1
(43) Pub. Date: Oct. 29, 2026

(54) SHEET CONVEYING APPARATUS AND IMAGE FORMING APPARATUS

(71) Applicant: CANON KABUSHIKI KAISHA, Tokyo (JP)

(72) Inventors: TOSHIYUKI ITO, Ibaraki (JP); HIROSHIGE INOUE, Tokyo (JP)

(21) Appl. No.: 19/569,125

(22) Filed: Mar. 17, 2026

(30) Foreign Application Priority Data
Apr. 23, 2025 (JP) 2025-071220

(51) Int. Cl. G03G 15/00; G03G 21/16

(52) U.S. Cl. CPC G03G 15/6567; G03G 15/6561; G03G 15/703; G03G 21/1633

(57) ABSTRACT

Disclosed is a sheet conveying apparatus including a conveying roller configured to convey a sheet; a first conveying path being disposed downstream of the conveying roller in a conveying direction; a second conveying path branching from the first conveying path; a moving member configured to be movable to a first position in which a sheet is guided to the first conveying path and a second position in which a sheet is guided to the second conveying path; and a supporting portion being configured to support the moving member. When the moving member is in the second position and a sheet is guided to the second conveying path, the moving member becomes in contact with the supporting portion. When the moving member is in the second position and a sheet is not guided to the second conveying path, the moving member does not become in contact with the supporting portion.

### BACKGROUND

### Field of the Technology

This disclosure relates to a sheet conveying apparatus and an image forming apparatus with the sheet conveying apparatus.

### DESCRIPTION OF THE RELATED ART

Recently, demands are increasing for performing an image for very thick sheets of paper such as printed packages, book covers, and direct mail pieces. Especially, when conveying a sheet of coated paper or film paper that are easily sucked with each other, multiple-feeding is likely to occur at a feeding portion. Japanese Patent Application Laid-open No. 2021-107283 discloses a sheet conveying apparatus that guides multiple-fed sheets to a multiple-fed-sheet accommodating portion by switching a switching member located downstream thereof.

However, when the multiple-fed sheets are guided to the multiple-fed-sheet accommodating portion, the switching member can be deformed by being pushed by the sheets. In this case, the sheets may be caught by a guide and so on disposed downstream of the switching member, causing a jam.

### SUMMARY

One aspect of the present disclosure is a sheet conveying apparatus comprising:
a conveying roller configured to convey a sheet;
a first conveying path through which a sheet passes, the first conveying path being disposed downstream of the conveying roller in a conveying direction;
a second conveying path through which a sheet passes, the second conveying path branching from the first conveying path;
a moving member configured to be movable to a first position in which a sheet is guided to the first conveying path and a second position in which a sheet is guided to the second conveying path; and
a supporting portion disposed at a central portion in a width direction perpendicular to the conveying direction of a sheet, the supporting portion being configured to support the moving member by becoming in contact with the central portion of the moving member in the width direction,
wherein when the moving member is in the second position and a sheet is guided to the second conveying path, the moving member becomes in contact with the supporting portion, and
wherein when the moving member is in the second position and a sheet is not guided to the second conveying path, the moving member does not become in contact with the supporting portion.

By the present disclosure, even when the rigidity of the moving member is not increased, the deformation of the moving member by being pushed by a sheet can be suppressed. As a result, a sheet can be conveyed without being caught by the guide and so on disposed downstream of the moving member.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram showing a cross-sectional view of an image forming apparatus according to an embodiment.

FIGS. 2A and 2B are schematic diagrams respectively showing a cross-sectional view and a top view of a feeding portion according to the embodiment.

FIG. 3 is a schematic diagram showing a cross-sectional view of a switching member and an accommodating portion of the embodiment.

FIG. 4 is a diagram showing a cross-sectional view for describing a switching operation according to the embodiment.

FIG. 5 is a diagram showing a cross-sectional view for describing a switching operation according the embodiment.

FIGS. 6A and 6B are diagrams each showing a cross-sectional view for describing the effects at a central supporting portion according the embodiment.

### DESCRIPTION OF THE EMBODIMENTS

Hereinafter, with reference to the drawings, an embodiment of the present disclosure will be exemplarily described. Sizes, materials, shapes of the components and relative arrangements thereof described in the following embodiment are exemplified and it is not intended that the scope of the present disclosure is limited to only those in the following embodiment.

### Image Forming Apparatus

First, the entire configuration of an image forming apparatus with a sheet conveying apparatus according to the present embodiment will be described.

Image forming apparatuses are classified as the tandem system in which image forming portions are disposed side by side and the rotary system in which image forming portions are disposed cylindrically. Further, in view of transfer system, image forming apparatuses are classified as the direct transfer system in which a toner image is transferred directly from a photosensitive member 508 to a sheet and the intermediate transfer system in which a toner image is temporarily transferred to an intermediate transfer member and further transferred to a sheet.

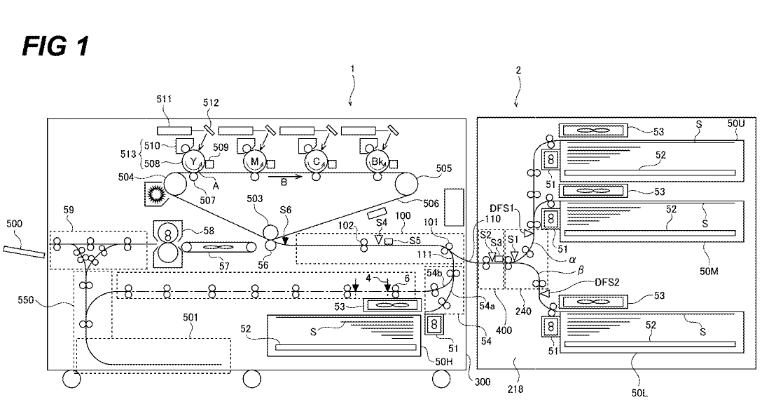

FIG. 1 is a diagram showing a cross-sectional view of the image forming apparatus of the intermediate tandem system in which image forming portions for four colors are disposed side by side along the intermediate transfer belt 506. In the intermediate transfer system, it is not necessary to hold a sheet on the transfer drum or the transfer belt like the direct transfer system, so that the intermediate transfer system can deal with various kinds of sheets such as very thick sheet of paper and the coated sheet. Furthermore, the intermediate transfer system has the features of parallel processing with image forming portions and the batch transfer of the full-color image. As a result, the intermediate transfer system is suited to the realization of the high productivity. Next, the operation of the image forming apparatus 1 will be described with reference to FIG. 1.

The sheets S are accommodated in the sheet accommodating portion 50H such that the sheets S are stacked on the lift-up apparatus 52 of the sheet accommodating portion 50H. The sheets S are fed by the sheet feeding portion. The sheet feeding portion is realized by the system in which the frictional separation by sheet feeding rollers is used or by the system in which separation and suction by air are used. The image forming apparatus 1 shown in FIG. 1 has the sheet feeding portion that employs the system in which separation and suction by air are used. In the sheet feeding portion, a sheet is floated by the air blown to the end portion of the sheet by the air blowing portion 51. After the floated sheet is sucked by the sucking and conveying portion 53, the sheet S is fed by the sucking and conveying portion 53 in synchronism with the image forming timing of the image forming apparatus.

The sheet S fed by the sheet feeding portion passes through the conveying path 54a of the conveying unit 54 and is further conveyed to the vertical confluent conveying path 111 in the registration unit 100. The registration unit 100 is provided with the pre-registration roller pair 101 (second pre-registration roller pair) that conveys a sheet, the registration roller pair 102 (the second registration roller pair) that adjusts the skew-feeding of the sheet, the registration sensor S4 (second pre-registration sensor) that detects the position of the sheet S in the conveying direction, and the contact image sensor S5 (second line sensor) that detects the position of the sheet in the width direction.

The leading end detecting sensor S6 that detects the leading end of the sheet S is disposed downstream of the registration unit 100. The delay time of the sheet S is measured by the leading end detecting sensor S6. The delay time is cancelled by changing the conveying speed of the sheet S according to the delay time. Thereafter, the sheet S is conveyed to the secondary transfer portion. The secondary transfer portion is a nipping portion formed by the second transfer inner roller 503 and the secondary transfer outer roller 56 that are opposed to each other for transferring a toner image onto the sheet S. By applying the pressing force an electrostatic load bias, a toner image is transferred onto the sheet S.

The sheet feeding apparatus 2 as a sheet conveying apparatus that conveys a sheet is connected the image forming apparatus 1. The sheet S fed from the sheet feeding apparatus 2 is conveyed to the registration unit 100 via the deck confluent conveying path 110. After the above process, the process for forming an image is performed.

The process will be described for forming an image that is conveyed to the secondary transfer portion in synchronism with the process of conveying the sheet S to the secondary transfer portion that has been already described above.

The image forming apparatus 1 is provided with the image forming portions 513 that form an image on a sheet. The image forming portions 513 are respectively provided for the colors yellow (Y), magenta (M), cyan (C) and black (Bk). Each of the image forming portions 513 is mainly provided with the photosensitive member 508, the exposure device 511, the developing device 510, the primary transfer device 507, and the photosensitive member cleaner 509 and so on. The photosensitive member 508 rotates in the direction shown by the arrow A in the figure. The surface of the photosensitive member 508 is previously and uniformly charged by a charging device. The exposure device 511 emits light based on a signal indicative of image information. The photosensitive member 508 is irradiated by the light traveled through the deflection portion 512 and so on. As a result, an electrostatic latent image is formed on the photosensitive member 508. The electrostatic latent image formed on the photosensitive member 508 is developed into an toner image on the photosensitive member 508 by the developing device 510. Thereafter, being given a predetermined pressing force and an electrostatic load bias by the primary transfer device 507, the toner image formed on the photosensitive member 508 is transferred onto the intermediate transfer belt 506. The toner images formed on the photosensitive members 508 for the colors yellow (Y), magenta (M), cyan (C) and black (Bk) are respectively sequentially transferred on the intermediate transfer belt 506 in a superimposed way. Thereafter, the remaining toner on the photosensitive member 508 is removed and collected to be prepared for the next image formation.

Next, the intermediate transfer belt 506 will be described. The intermediate transfer belt 506 is stretched by the stretching rollers such as the driving roller 504, the tension roller 505 and the secondary transfer inner belt 503 and is driven to be conveyed in the direction indicated by the arrow B in the figure. The processes for forming images of colors parallelly processed by the respective image forming portions 513 for the colors yellow (Y), magenta (M), cyan (C) and black (Bk) are performed at the timing when the images of colors are superimposed on the upstream toner images primarily transferred on the intermediate transfer belt 506. As a result, a full-color toner image in which toner images of the respective colors are superimposed with each other is formed on the intermediate transfer belt 506 and is finally conveyed to the secondary transfer portion.

After performing the process of conveying the sheet S and the process of forming an image, which have been already described above, a full-color toner image is secondarily transferred onto the sheet S at the secondary transfer portion. Thereafter, the sheet S is conveyed to the fixing device 58 by the pre-fixing sheet conveying device 57. The fixing device 58 melts and fixes the toner on the sheet S by applying a predetermine pressing force by rollers that are approximately opposed with each other or a belt and heat by a heat source such as a heater. The sheet S with a fixed image obtained in this way is discharged directly onto the discharge tray 500 or switched back at the reverse discharge portion 550 for the front surface and back surface of the sheet S to be reversed and discharged onto the discharge tray 500 by the branch conveying device 59. When an image should be formed on both surfaces of the sheet S, the sheet S is conveyed to the double-sided reverse conveying device 501.

When the leading end of the sheet S conveyed to the double-sided reverse conveying device 501 is detected by the detecting portion 4 that is provided in the double-sided conveying path for detecting the leading end of the sheet S, the sheet S is temporarily stopped in the double-sided reverse conveying path. Thereafter, the sheet S is conveyed to the vertical confluent conveying path 111 in the registration unit 100 via the conveying path 54b to form an image for the second surface. After an image is formed on the second surface of the sheet S likewise on the first surface, the sheet S is discharged onto the discharge tray 500.

### Sheet Feeding Device

Upstream of the deck confluent conveying path 110 in the image forming apparatus 1, the sheet feeding device 2 as a sheet conveying apparatus is disposed. In the sheet feeding device 2, three sheet accommodating portions 50U, 50M and 50L that have the same configuration as that of the sheet accommodating portion 50H in the image forming apparatus 1 are provided along the upward and downward directions. The sheets S in the sheet accommodating portions are fed by respective sheet feeding portions.

The upper sheet accommodating portion 50U is located in the highest position among the three sheet accommodating portions. The middle sheet accommodating portion 50M is located in the second highest position among the three sheet accommodating portions. The lower sheet accommodating portion 50L is located in the third highest position among the three sheet accommodating portions. The sheets S in each of the sheet accommodating portions 50U, 50M and 50L are stacked on the lift-up device 52.

The sheet S in each of the sheet accommodating portions 50U, 50M and 50L is fed by a sheet feeding portion that is the same configuration as that of the sheet accommodating portion 50H. The sheet feeding device 2 shown in FIG. 1 also has a sheet feeding portion of the system in which separation and suction of the sheets are performed by air likewise the image forming apparatus 1. The sheet feeding portion floats a sheet by blowing air to the end portion of the sheet by the air blowing portion 51 and feeds the sheet S by the sucking and conveying portion 53 after the floated sheet is sucked to the sucking and conveying portion 53.

The sheet S fed from the upper sheet accommodating portion 50U that is in the highest position among the three sheet accommodating portions and the middle sheet accommodating portion 50M that is in the second highest position is conveyed via the upper conveying path α. The sheet S fed from the lower sheet accommodating portion 50L that is in the third highest position is conveyed via the lower conveying path β.

The sheet S fed from each of the sheet accommodating portions 50U, 50M or 50L is conveyed via the registration unit 240 and the discharge unit 400 in this order in the sheet feeding device 2 and is further conveyed to the image forming apparatus 1 in synchronism with the image forming timing according to the image forming apparatus 1 likewise the image forming apparatus 1.

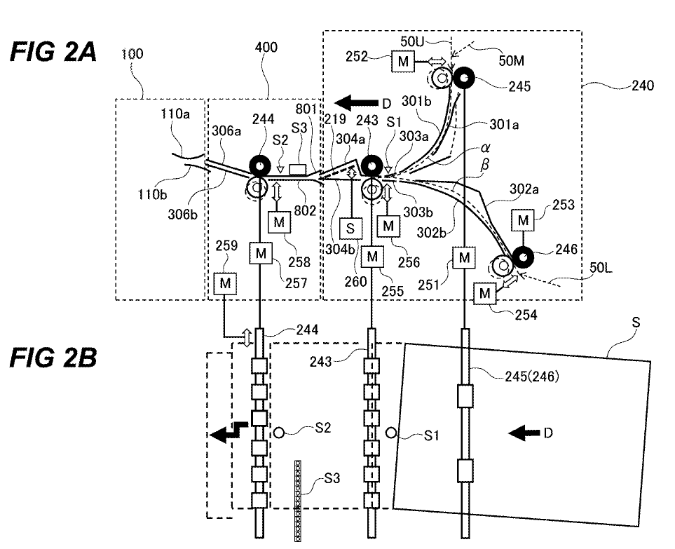

Next, the registration unit 240 and the discharge unit 400 in the sheet feeding device 2 will be described referring to FIGS. 2A and 2B. FIG. 2A is a schematic diagram showing a cross-sectional view of the registration unit 240 and the discharge unit 400 in the sheet feeding device 2, and a part of the registration unit 100 in the image forming apparatus 1. FIG. 2B is a diagram showing a top view of conveying rollers and sensors of the registration unit 240 and the discharge unit 400 in the sheet feeding device 2.

The registration unit 240 is provided with the conveying rollers 245, 246 and 243 that convey the sheet S. The registration unit 240 is further provided with the upper conveying guides 301a and 301b, the lower conveying guides 302a and 302b, and the conveying guides 303a, 303b, 304a and 304b that guide the sheet S. The registration unit 240 is furthermore provided with the detection sensor S1 that detects the sheet S.

The conveying rollers 245 are a roller pair that nips and conveys a sheet. One roller is driven to rotate by the motor 251 and the other roller comes in contact with the one roller and is separated from the one roller by the motor 252. The sheet S fed from the upper sheet accommodating portion 50U or the middle sheet accommodating portion 50M is conveyed by the conveying rollers 245. The sheet S conveyed by the conveying rollers 245 is guided by the upper conveying guides 301a and 301b that form the upper conveying path α and is conveyed to the conveying rollers 243 via the conveying guides 303a and 303b that form a confluent path of the upper conveying path α and the lower conveying path β.

The conveying rollers 246 are a roller pair that nips and conveys a sheet. One roller is driven to rotate by the motor 253 and the other roller comes in contact with the one roller and is separated from the one roller by the motor 254. The sheet S fed from the lower sheet accommodating portion 50L is conveyed by the conveying rollers 246. The sheet S conveyed by the conveying rollers 246 is guided by the upper conveying guides 302a and 302b that form the lower conveying path β and is conveyed to the conveying rollers 243 via the conveying guides 303a and 303b that form a confluent path of the upper conveying path α and the lower conveying path β.

The conveying guides 303a and 303b are disposed between the upper conveying guides 301a, 301b, the lower conveying guides 302a, 302b, and the conveying rollers 243. The detection sensor S1 is disposed at the confluent path formed by the conveying guides 303a and 303b for detecting the sheet S.

The conveying rollers 243 are a roller pair that nips and conveys a sheet. One roller is driven to rotate by the motor 255 and the other roller comes in contact with the one roller and is separated from the one roller by the motor 256. The sheet S guided to the conveying rollers 243 by the conveying guides 303a and 303b is conveyed by the conveying rollers 243. The sheet S conveyed by the conveying rollers 243 is guided to the conveying guides 304a and 304b that form a conveying path and is conveyed to the discharge unit 400.

In this way, the sheet S conveyed via the upper conveying path α or the lower conveying path β is further conveyed to the horizontal path in the discharge unit 400 by the conveying rollers 243 in the registration unit 240.

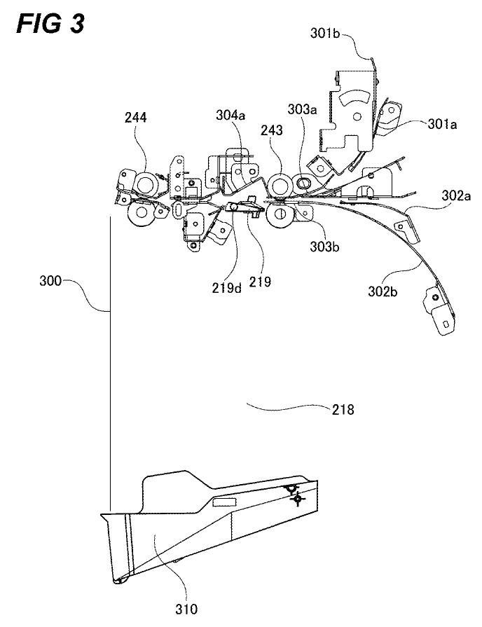

The registration unit 240 is provided with the switching member 219 (moving member) and the multiple-fed sheet accommodating portion 218 (see FIG. 3). These will be described later.

The discharge unit 400 is provided with the registration roller pair 244 that has conveying rollers for conveying the sheet S, and adjusts the skew-feeding of the sheet S. The discharge unit 400 is provided with the conveying guides 801, 802, 306a and 306b. The discharge unit 400 is further provided with the detection sensors S2 and S3 for detecting the sheet S.

The conveying guides 801 and 802 receive the sheet S sent from the registration unit 240 and guides the sheet S to the registration roller pair 244. The detection sensor S3 is fixed to the conveying guide 801. The conveying guide 802 is opposed to the conveying guide 801.

The registration roller pair 244 nips and conveys a sheet. One roller is driven to rotate by the motor 257 and the other roller comes in contact with the one roller and is separated from the one roller by the motor 258. The sheet S guided to the registration roller pair 244 by the conveying guides 801 and 802 is further conveyed by the registration roller pair 244. The registration roller pair 244 is driven to rotate according to the image forming timing of the image forming apparatus 1. The sheet S conveyed by the registration roller pair 244 is guided by the conveying guides 306a and 306b that form a conveying path and is further conveyed to the registration unit 100 in the image forming apparatus 1.

In the discharge unit 400, when the leading end of the sheet S is detected by the detection sensor S2 disposed in the horizontal path, the sheet S temporarily stops. The sheet S is fed to the image forming apparatus 1 according to the image forming timing of the image forming apparatus 1 by the registration roller pair 244. As a result, the unevenness of the conveying timings occurred at the sucking and conveying portions 53 of the sheet accommodating portions 50U, 50M and 50L can be adjusted. Thereafter, the subsequent sheet S is likewise fed from the sheet feeding device 2 to the image forming apparatus 1.

Further, the sheet S fed to the image forming apparatus 1 is guided to the pre-registration roller pair 101 by the conveying guides 110a and 110b that form a conveying path that is confluent to the vertical confluent conveying path 111 in the registration unit 100.

The sheet S conveyed via the upper conveying path α or the lower conveying path β can be skew-fed as shown in FIG. 2B. The direction indicated by the arrow D in FIG. 2B is a conveying direction of the sheet S.

The sheet S conveyed via the upper conveying path α or the lower conveying path β is conveyed by the conveying rollers 243 after the leading end of the sheet S is detected by the detection sensor S1. The leading end of the sheet S conveyed by the conveying rollers 243 abuts against the nip portion of the registration roller pair 244 that is stopped and the sheet S is conveyed, so that the inclination of the sheet leading end is adjusted. At this time, a loop of the sheet S is formed between the conveying rollers 243 and the registration roller pair 244 in the space between conveying guides 304a and 304b.

The sheet S whose leading end's inclination has been adjusted is fed from the sheet feeding apparatus 2 to the image forming apparatus 1 by the registration roller pair 244 being driven to rotate. At this time, the registration roller pair 244 is driven to rotate in synchronism with the image forming timing of the image forming apparatus 1. The registration roller pair 244 is provided to be movable in the width direction perpendicular to the conveying direction of the sheet S and is moved in the width direction by the motor 259. The moving amount in the width direction of the registration roller pair 244 is set in response to a signal from the detection sensor S3 that detects the position of the end portion of the sheet S in the width direction, and the registration roller pair 244 is moved in the width direction for the set moving amount to adjust the skew-feeding of the sheet S. When the sheet S is moved in the width direction by the registration roller pair 244, the rollers of the other rollers that nip the sheet S are separated from each other, so that the movement of the sheet S in the width direction is not disturbed.

In this way, the skew-feeding of the sheet S is adjusted. The above described configuration for skew-feeding adjustment of the sheet S is just an example and the configuration is not limited to the above. For example, other configurations can be adopted such as the configuration in which an image (toner image) formed by the image forming portion is moved in the width direction for the sheet S whose leading end's inclination is adjusted.

### Switching Member and Multiple-fed Sheet Accommodating Portion

The sheet feeding device 2 as a sheet conveying apparatus is provided with the switching member 219 and the multiple-fed sheet accommodating portion 218. Referring to FIGS. 3-6, the switching member 219 and the multiple-fed sheet accommodating portion 218 of the sheet feeding device 2 will be described.

### Multiple-fed Sheet Accommodating Portion

First, referring to FIG. 3, the switching member 219 and the multiple-fed sheet accommodating portion 218 of the sheet feeding device 2 will be described. FIG. 3 is a diagram showing a cross-sectional view of the multiple-fed sheet accommodating portion 218.

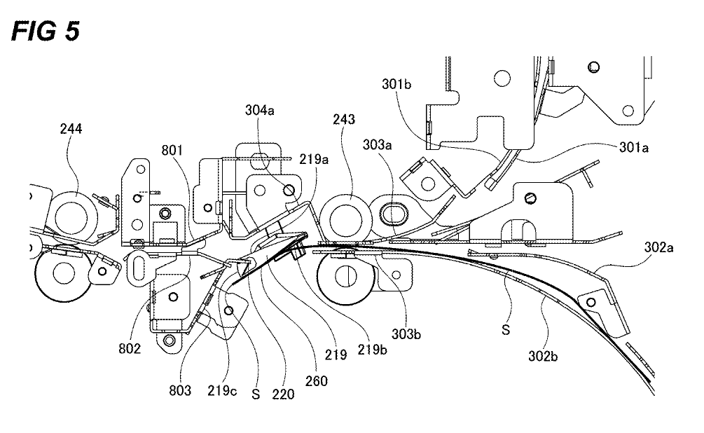

The multiple-fed sheet accommodating portion 218 is provided with the accommodating tray 310 as an accommodating portion in which multiple-fed sheets S are accommodated. The multiple-fed sheet accommodating portion 218 is adjacent to the door portion 300 provided to be openable and closable with respect to the sheet feeding device 2. The leading end of the sheet S whose direction is switched towards the multiple-fed sheet accommodating portion 218 by the switching member 219 abuts against the door portion 300, so that the door portion 300 is configured as a guide portion that guides the leading end of the abutting sheet S towards the accommodating tray 310. Namely, the door portion 300 serves as a guide portion that guides the sheet S guided to the second conveying path by the switching member 219 towards the accommodating tray 310. The second conveying path is formed by the later described conveying guide 803 (see FIG. 5) and the door portion 300 and is a conveying path branched from the conveying path (first conveying path) formed by the conveying guides 304a and 304b.

### Switching Member

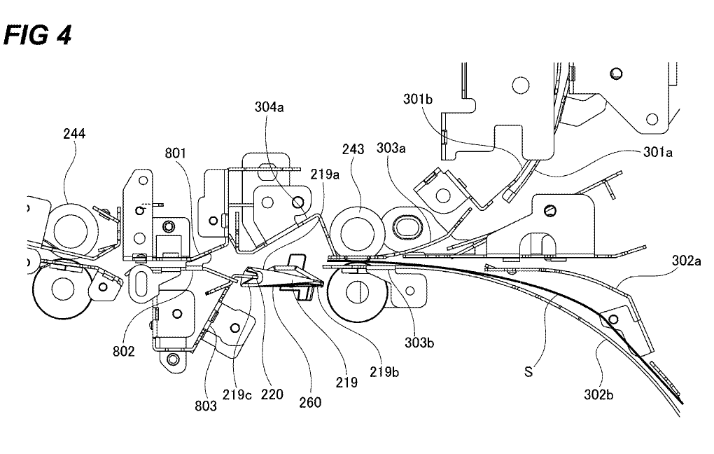

Referring to FIGS. 4 and 5, the switching member 219 of the feeding device 2 will be described. FIGS. 4 and 5 are diagrams for illustratively describing the operation of the switching member 219 in the case where the sheets S conveyed from the lower sheet accommodating portion 50L are multiple-fed.

The switching member 219 is disposed downstream of the conveying rollers 243 in the conveying direction. The switching member 219 is a moving member that is movable to the first position (position shown in FIG. 4) in which the sheet S is guided to the first conveying path and the second position (position shown in FIG. 5) in which the sheet S is guided to the second conveying path. The switching member 219 is switched to the first portion and the second position.

The sheet feeding device 2 is provided with the central supporting portion 220 as a supporting portion. The central supporting portion 220 is disposed at the central portion in the width direction perpendicular to the conveying direction of the sheet S. The central supporting portion 220 supports the switching member 219 by being contact with the central portion of the switching member 219 in the width direction.

The switching member 219 is provided with the first guide portion 219a that guides the sheet S to the first conveying path, the second guide portion 219b that is provided at the opposite side of the first guide portion 219a and that guides the sheet S to the second conveying path, and the concave portion 219c. The concave portion 219c as a contact portion is in contact with the central supporting portion 220 between the first guide portion 219a and the second guide portion 219b. The concave portion 219c is not in contact with the central supporting portion 220 when the sheet S is not guided to the first guide portion 219a and the second guide portion 219b. In this embodiment, the configuration that the concave portion 219c is formed between the first guide portion 219a and the second guide portion 219b is exemplified as a contact portion, however, the configuration of the the concave portion 219c is not limited to this. As long as the contact portion is provided between the first guide portion 219a and the second guide portion 219b and is in contact with the central supporting portion 220, another configuration can be adopted.

When the sheet S is guided to the first guide portion 219a or the second guide portion 219b, the central supporting portion 220 is in contact with the central portion of the switching member 219 and supports the switching member 219. Namely, when the sheet S is guided, the switching member 219 is elastically deformed and the central portion of the switching member 219 becomes in contact with the central supporting portion 220, so that the central supporting portion 220 supports the switching member 219.

The sheet feeding device 2 is provided with the multiple-feed detection sensors DFS1 and DFS2 (see FIG. 1) as detection portions that detect multiple-feed of the sheets S. As shown in FIG. 1, the multiple-feed detection sensor DFS1 is disposed on the upper conveying path α formed by the upper conveying guides 301a and 301b and detects the multiple-feed of the sheets S guided to the conveying rollers 243 via the upper conveying path α. The multiple-feed detection sensor DFS2 is disposed on the lower conveying path β formed by the lower conveying guides 302a and 302b and detects the multiple-feed of the sheets S guided to the conveying rollers 243 via the lower conveying path β.

When the multiple-feed is not detected by the multiple-feed detection sensors DFS1 and DFS2, the sheet is guided to the first conveying path by the switching member 219 being switched to the first position shown in FIG. 4. Whereas when the multiple-feed is detected by the multiple-feed detection sensors DFS1 and DFS2, the sheet is guided to the second conveying path by the switching member 219 being switched to the second position shown in FIG. 5. In this way, when the sheet S is guided, the switching member 219 is elastically deformed and the central portion of the switching member 219 becomes in contact with the central supporting portion 220, so that the central supporting portion 220 supports the switching member 219.

The registration roller pair 244 is disposed downstream of the switching member 219 in the conveying direction and adjusts the skew-feeding of the sheet S as described above. When the first guide portion 219a of the switching member 219 in the first position shown in FIG. 4, the first guide portion 219a abuts the leading end of the sheet S conveyed by the conveying rollers 243 against the nip portion of the registration roller pair 244 to configure a space for forming a loop of the sheet S between he conveying rollers 243 and the registration roller pair 244. Specifically, the first guide portion 219a of the switching member 219 configures a space for forming a loop between the first guide portion 219a and the conveying guide 304a, in the first position shown in FIG. 4 in the space between the conveying guides 304a and 304b shown in FIG. 2A.

The switching member 219 is driven by the solenoid 260 (see FIG. 2A) as a driving portion. The switching member 219 is of a long shape in the width direction and is provided with the rotatably supporting portions 219d (see FIG. 3) that rotatably support the switching member 219 at the both ends of the switching member 219 in the width direction. Therefore, the switching member 219 is driven by the solenoid 260 and is moved to first position shown in FIG. 4 or to the second position shown in FIG. 5 around the rotation center of the rotatably supporting portions 219d.

The sheet feeding device 2 is provided with the conveying guide 803 as a guid member that guides the sheet S. The conveying guide 803 is disposed downstream of the switching member 219 in the conveying direction. The conveying guide 803 guides the sheet S guided to the second conveying path by the switching member 219 towards the accommodating tray 310. The conveying guide 803 forms the second conveying path branched from the conveying path (first conveying path) formed by the conveying guides 304a and 304b. The central supporting portion 220 is provided on the conveying guide 803. Specifically, the central supporting portion 220 is disposed at the end portion on the upstream side of the conveying guide 803 in the conveying direction to protrude from the end portion to the upstream side in the conveying direction. Further, the central supporting portion 220 is disposed at the center of the conveying guide 803 in the width direction.

In the sheet feeding device 2 shown in FIG. 4, the switching member 219 that has been switched in the first position in which the sheet S is guided to the first conveying path is shown. When the switching member 219 is switched to the first position, the first guide portion 219a is located under the sheet S conveyed by the conveying rollers 243 to be in the state where the sheet S is guided to the deck confluent conveying path 110. In this state, in the sheet feeding device 2, the multiple-feed detection sensor DFS2 detects that the sheets S conveyed from the lower sheet accommodating portion 50L via the lower conveying path β are multiple-fed.

In the sheet feeding device 2 shown in FIG. 4, while the sheet S is detected to be present on the switching member 219 on the downstream side of the conveying rollers 243 in the conveying direction by the detection sensor S1, the position of the switching member 219 is maintained to the first position (first guide position) in which the sheet S is guided to the first conveying path that goes towards the image forming apparatus 1. Further, in the sheet feeding device 2, when the multiple-feed of the sheets S is detected by the multiple-feed detection sensor DFS2, the driving of the rotation of the conveying rollers 243 is stopped. As a result, in the sheet feeding device 2, the conveyance of the sheets S whose multiple-feed is detected is temporarily stopped.

In the sheet feeding device 2 shown in FIG. 5, when the detection sensor S1 detects that the sheet S is absent on the switching member 219, the solenoid 260 is driven, so that the switching member 219 is moved from the first position (first guide position) to the second position (second guide position) in which the sheet S is guided to the second conveying path that goes towards the multiple-feeding sheet accommodating portion 218. In the sheet feeding device 2, when the switching member 219 is moved to the second position (second guide position), the driving of the rotation of the conveying rollers 246 is resumed. Further, in the sheet feeding device 2, the multiple-fed sheets S are conveyed to the switching member 219 by the conveying rollers 243, become in touch with the second guide portion 219b of the switching member 219, and are guided to the second conveying path that goes towards the multiple-feeding sheet accommodating portion 218.

In order to be able to convey the multiple-fed sheets S even when the multiple-fed sheets S are thick sheets of paper, the conveying rollers 243 are a roller pair whose conveying pressure is set to be high, so that the conveying rollers 243 have a conveying force such that even a several multiple-fed sheets can be conveyed without slip.

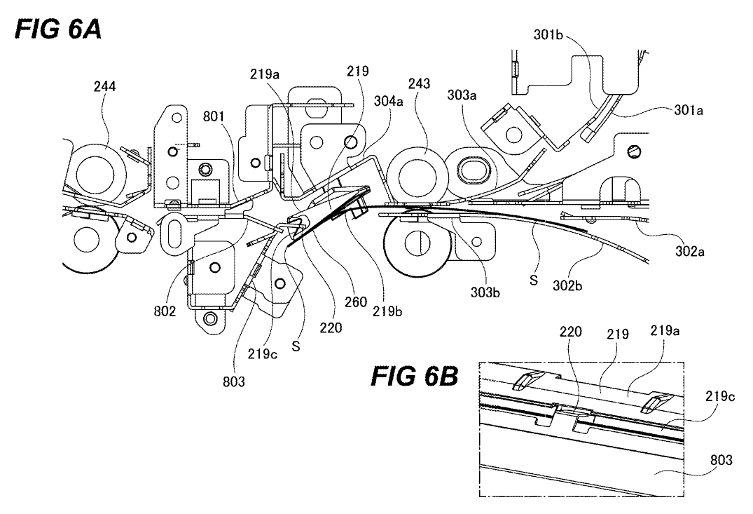

The function and effect of the central supporting portion 220 for the switching member 219 will be described referring to FIGS. 6A and 6B. FIG. 6A is a diagram showing a cross-sectional view of the switching member 219 at the central supporting portion 220. FIG. 6B is a diagram showing perspective view of a main part of the central supporting portion 220 of the switching member 219.

As shown FIGS. 6A and 6B, the switching member 219 is disposed downstream of the conveying rollers 243 in the conveying direction, is thin in the substantially vertical direction perpendicular to the conveying direction and the width direction, and is a shape that is long in the width direction. Further, the switching member 219 is made from resin. Therefore, when several multiple-feeding sheets conveyed by the conveying rollers 243 become in contact with and press the switching member 219, the central portion of the switching member 219 in the width direction (longitude direction) is easy to deform in the direction (substantially vertical direction in the figure) perpendicular to the conveying direction.

The switching member 219 according to the present disclosure is adjacent to the central supporting portion 220 configured on the down stream conveying guide 803 that guides the multiple-fed sheets to the multiple-feeding sheet accommodating portion 218. Even when the switching member 219 is deflected by the sheets S whose rigidness becomes seemingly larger due to multiple-feeding, the switching member 219 becomes in contact with the central supporting portion 220, so that the the central portion of the switching member 219 is supported by the central supporting portion 220. In this case, the switching member 219 is supported by the first guide portion 219a side of the concave portion 219c as a contact portion becoming in contact with the central supporting portion 220 as shown in FIG. 5, or by the second guide portion 219b side of the concave portion 219c becoming in contact with the central supporting portion 220 as shown in FIG. 6. As a result, the deformation amount of the switching member 219 in passing the multiple-fed sheets to the multiple-feeding sheet accommodating portion 218 can be reduced. Therefore, even in a conveying device in an image forming apparatus that deals with thick sheets of paper with high rigidity, multiple-fed sheets are surely conveyed and guided to the multiple-feeding sheet accommodating portion 218.

In the present embodiment, even when the rigidity of the switching member 219 is not increased, the deformation of the switching member 219 due to the switching member 219 being pushed by the sheet S can be prevented. As a result, the sheet S can be conveyed without being caught by the guides and so on disposed downstream of the switching member 219.

In the above embodiment, a sheet feeding device as a sheet conveying apparatus that is detachably attached to the image forming apparatus is exemplified. However, the configuration is not limited to this one. For example, the sheet conveying apparatus can be integrally provided with the image forming apparatus. By applying the present disclosure to such sheet conveying apparatus, the same effect can be obtained.

In the above embodiment, the sheet conveying apparatus that conveys a sheet such as a recording material to which an image is to be recorded is exemplified. However, the configuration is not limited to this one. For example, by applying the present disclosure to the sheet conveying apparatus that conveys a sheet of a document to be read, the same effect can be obtained.

In the above embodiment, the electrophotographic system is exemplified as a recording system. However, the configuration is not limited to this one and another recording system such as an ink jet system can be adopted.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-071220, filed Apr. 23, 2025, which is hereby incorporated by reference herein in its entirety.

What is claimed is:

1. A sheet conveying apparatus comprising:
a conveying roller configured to convey a sheet;
a first conveying path through which a sheet passes, the first conveying path being disposed downstream of the conveying roller in a conveying direction;
a second conveying path through which a sheet passes, the second conveying path branching from the first conveying path;
a moving member configured to be movable to a first position in which a sheet is guided to the first conveying path and a second position in which a sheet is guided to the second conveying path; and
a supporting portion disposed at a central portion in a width direction perpendicular to the conveying direction of a sheet, the supporting portion being configured to support the moving member by becoming in contact with the central portion of the moving member in the width direction,
wherein when the moving member is in the second position and a sheet is guided to the second conveying path, the moving member becomes in contact with the supporting portion, and
wherein when the moving member is in the second position and a sheet is not guided to the second conveying path, the moving member does not become in contact with the supporting portion.

2. The sheet conveying apparatus according to claim 1,
wherein when the moving member is in the second position and a sheet is guided to the second conveying path, the moving member is deformed by a sheet abutting against the moving member and becomes in contact with the supporting portion.

3. The sheet conveying apparatus according to claim 1,
wherein the moving member is provided with a first guide portion configured to guide a sheet to the first conveying path, a second guide portion configured to guide a sheet to the second conveying path, the second guide portion being provided at an opposite side of the first guide portion, and a contact portion configured to become in contact with the supporting portion between the first guide portion and the second guide portion, and
wherein when the moving member is in the second position and a sheet is guided to the second conveying path, the contact portion becomes in contact with the supporting portion.

4. The sheet conveying apparatus according to claim 3,
wherein a concave portion is formed on the contact portion between the first guide portion and the second guide portion.

5. The sheet conveying apparatus according to claim 1,
wherein the moving member is of a shape that is long in the width direction, and
wherein the moving member is provided with a rotatably supporting portion that rotatably supports the moving member at both ends of the moving member in the width direction.

6. The sheet conveying apparatus according to claim 1,
wherein the moving member is made from resin.

7. The sheet conveying apparatus according to claim 1, further comprising:
a detection portion configured to detect multiple-feed of sheets,
wherein when the multiple-feed is not detected by the detection portion, the moving member is moved to the first position so that a sheet is guided to the first conveying path, and
wherein when the multiple-feed is detected by the detection portion, the moving member is moved to the second position so that a sheet is guided to the second conveying path.

8. The sheet conveying apparatus according to claim 3, further comprising:
a registration roller pair disposed downstream of the moving member in the conveying direction, the registration roller pair being configured to adjust a skew-feeding of a sheet,
wherein at least one of the guide portions of the moving member configures a space for forming a loop of a sheet between the conveying roller and the registration roller pair by abutting a leading end of a sheet conveyed by the conveying roller against a nip portion of the registration roller pair.

9. The sheet conveying apparatus according to claim 1, further comprising:
a driving portion configured to move the moving member to the first position or the second position.

10. The sheet conveying apparatus according to claim 1, further comprising:
an accommodating portion configured to accommodate multiple-fed sheets; and
a door portion provided adjacent to the accommodating portion, the door portion being configured to be openable and closable,
wherein the door portion guides a sheet having been guided to the second conveying path by the moving member towards the accommodating portion.

11. The sheet conveying apparatus according to claim 1, further comprising:
a guide member disposed downstream of the moving member in the conveying direction, the guide member being configured to guide a sheet having been guided to the second conveying path by the moving member,
wherein the supporting portion is provided on the guide member.

12. An image forming apparatus comprising:
a sheet conveying apparatus according to claim 1; and
an image forming portion configured to form an image on a sheet.
